(19) United States
(12) Patent Application Publication
(10) Pub. No.: US 2010/0072412 A1
(43) Pub. Date: Mar. 25, 2010

(54) VALVE BLOCK

(76) Inventors: Holger Frank, Gliching (DE); Jörg Binder, Rotenbach (DE); Andreas Derr, Wutoschingen (DE); Lutz Gutzeit, Weimar (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/448,315

(22) PCT Filed: Dec. 18, 2007
(86) PCT No.: PCT/EP2007/011094

§ 371 Date: Nov. 2, 2009

(30) Foreign Application Priority Data
Dec. 20, 2006 (DE) 10 2006 060 923.9

(51) Int. Cl. F16K 51/00; B21K 1/20

(52) U.S. Cl. 251/366; 251/368; 29/890.124

(57) ABSTRACT

A valve block includes at least a first connection and a second connection. Both connections are connected to each other inside the valve block to temporarily change flow paths in a coolant device and/or to fill the coolant device and/or empty the coolant device. The valve block may be made of a coolant and pressure-resistant plastic and may be manufactured by an injection molding method.

The present invention relates to a valve block according to the definition of the species in Patent Claim 1.

Valve blocks which have at least one first and one second connection, which are connected within the valve block, are known. This makes it possible to temporarily change flow paths in a cooling medium system, to fill or drain the cooling medium system.

The known valve blocks are either cut from a solid block or designed as a semifinished product. The manufacture of the valve blocks is therefore cost-intensive and barely allows a flexible design of the valve blocks.

The object of the present invention is therefore to provide a valve block which may be manufactured cost-effectively, while a flexible design of the valve block is made possible.

The object of the present invention is achieved by a valve block having the features of Patent Claim 1 and a method for manufacturing the valve block having the features of Patent Claim 15.

The subclaims provide advantageous embodiments and refinements of the present invention.

According to the present invention, the valve block is manufactured from a cooling medium-resistant and pressure-resistant plastic. Plastic is processable in a particularly simple and flexible way, so that the manufacturing costs for the manufacture of the valve block are significantly reduced. Complex machining of metals, involving a plurality of reworking steps, is therefore not needed.

To meet the requirements for a valve block, the valve block is preferably manufactured from a plastic which is pressure-resistant to approximately 150 bar.

To achieve the desired pressure resistance, the plastic is preferably a plastic reinforced by additives. It is particularly preferably a fiber-reinforced, preferably a fiberglass-reinforced, plastic.

The use of plastic as the material for the valve block has the particular advantage that the valve block may be manufactured by the injection molding method. Manufacturing the valve block from plastic by the injection molding method has the advantage that plastic is particularly easy to process and shape in a variety of shapes in a flexible manner. Therefore it is possible to vary the design of the valve block in a simple manner, in particular to integrate additional functions into the valve block.

In a particularly preferred specific embodiment of the present invention, the valve block has structural elements to increase its stability. These structural elements may be designed, for example, as arches and/or ribs on the housing, in particular on the outside of the housing of the valve block, which in turn preferably have further structural elements such as openings, for example, circular openings. Structural elements of this type may, on the one hand, drastically reduce the weight of the valve block and material may be saved.

Furthermore, the stability of the valve block is enhanced, which is an advantage in particular at a high pressure.

The valve block preferably has a third and/or a fourth connection to increase the options of modifying the flow paths and, in particular, to make it possible to fill and/or drain the valve block at the same time when the flow paths are modified.

In a particularly preferred specific embodiment of the present invention, the connections are molded, in particular extruded, onto the valve block. This makes it possible to dispense with the separate manufacturing of the connections, which may thus be placed on the valve block without risk of being lost. In addition, the manufacturing costs are further reduced.

In an advantageous refinement of the present invention, at least one receptacle for a valve is formed on the valve block, the valve making it possible to open and close one of the connections. By being able to mold receptacles of this type directly into the plastic of the valve block, complex reworking of the valve block may be dispensed with.

Catch projections are preferably situated on the valve block, which cooperate with mating catch projections of a valve in such a way that the valve height is adjustable. Catch projections of this type may be formed directly during the manufacture of the valve block without cost-intensive reworking or additional machining operations being needed.

In a particularly preferred specific embodiment of the present invention, an opening for placing a sight glass is formed in the valve block. A sight glass of this type makes it possible to monitor whether air bubbles are present in the cooling medium or to monitor the velocity of the cooling medium's flow through the valve block.

The valve block according to the present invention is preferably used in a control armature for measuring, monitoring, and analyzing physical parameters of recirculating cooling media.

In a particularly advantageous embodiment of the present invention, the control armature has a sight glass, which is preferably illuminatable to make monitoring of the cooling medium flowing through the valve block easy for the user.

The method according to the present invention for manufacturing a valve block according to the present invention is based on manufacturing the valve block by the injection molding method. A method is thus used which is cost-effective in particular and makes it possible to design the valve block considerably more flexibly than when the valve block is cut from a solid block. In particular, the valve block becomes lighter-weight due to the use of plastic, which is advantageous in particular for portable devices containing a valve block. In addition, the injection molding method makes it possible to design the valve block to have many more structures without additional machining operations than would be possible in a cutting method, the structures being able to perform different functions of the valve block. No complex reworking of the corresponding structures is needed.

The present invention is described in greater detail with reference to the figures below.

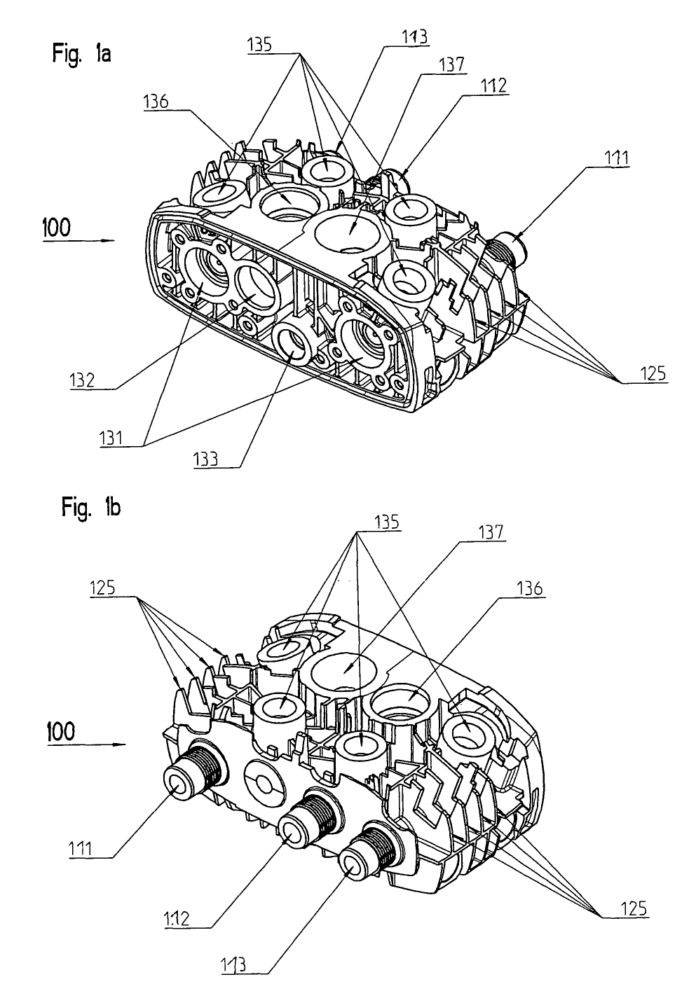

FIG. 1a shows a perspective view of a first exemplary embodiment of a valve block according to the present invention;

FIG. 1b shows another perspective view of the first exemplary embodiment of the valve block according to FIG. 1a;

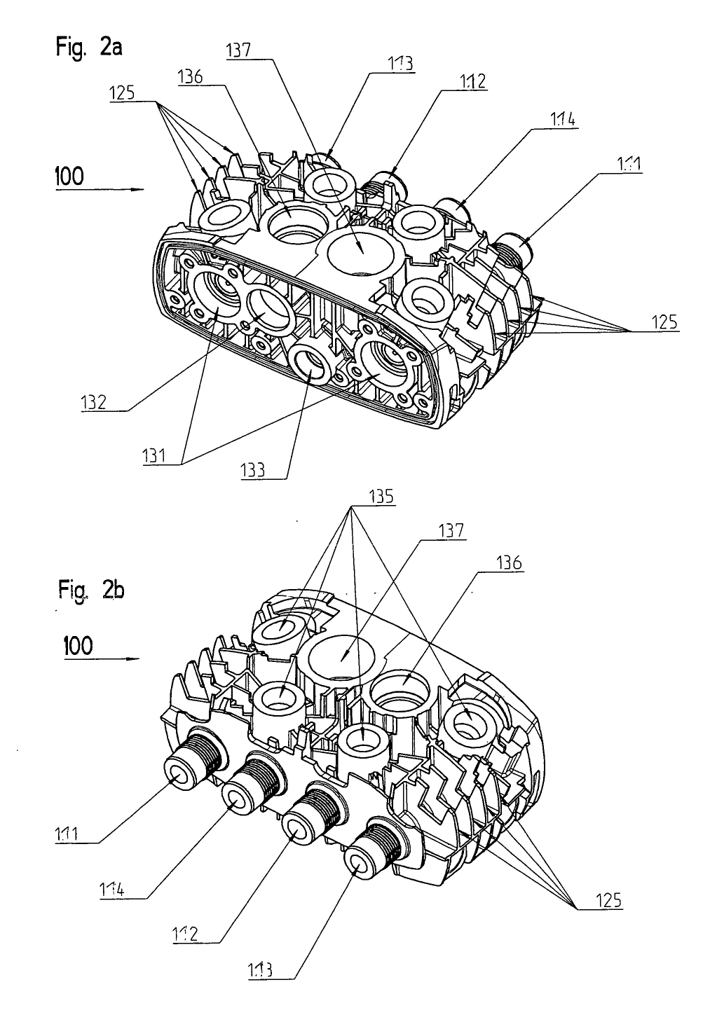

FIG. 2a shows a perspective view of a second exemplary embodiment of a valve block according to the present invention;

FIG. 2b shows another perspective view of the second exemplary embodiment of the valve block according to FIG. 2a;

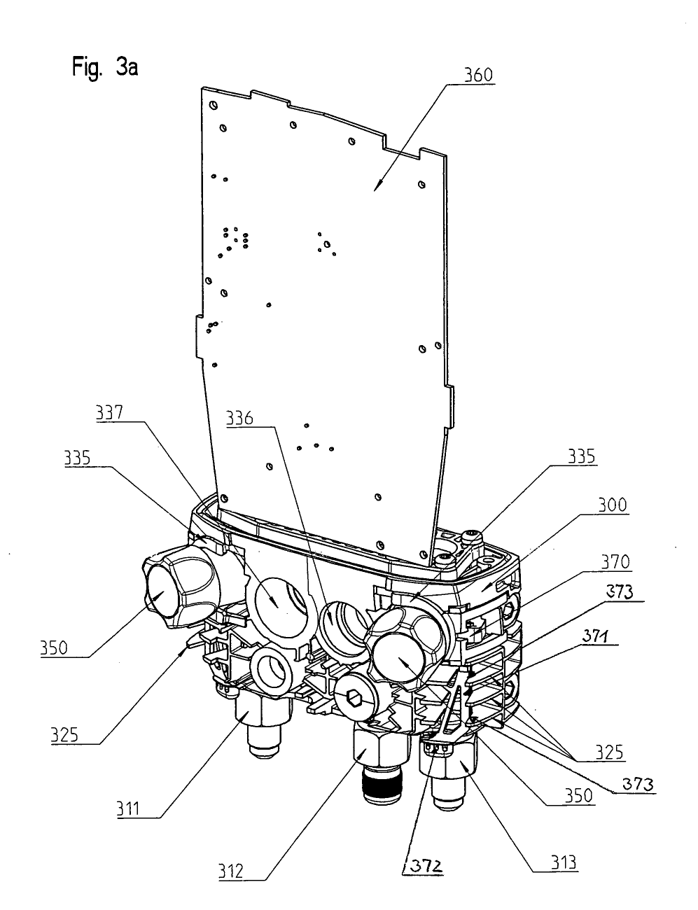

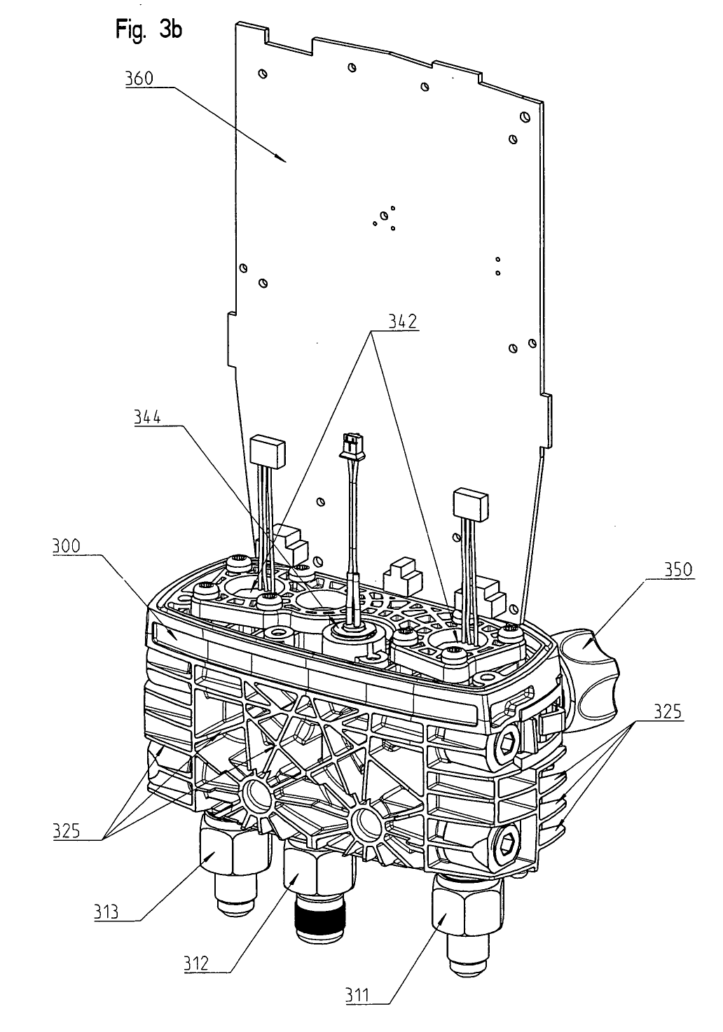

FIG. 3a shows a perspective view of a third exemplary embodiment of a valve block according to the present invention;

FIG. 3b shows another perspective view of the third exemplary embodiment of the valve block according to FIG. 3a; and

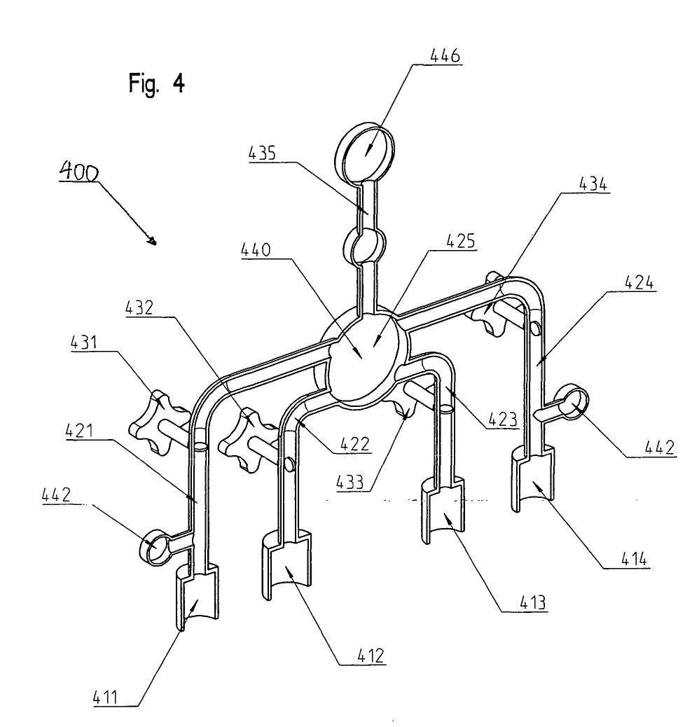

FIG. 4 shows a schematic view of a diagram of a fourth exemplary embodiment of a valve block.

FIGS. 1a and 1b show two different perspective views of a first exemplary embodiment of a valve block 100. Valve block 100 has a first connection 111, a second connection 112, and a third connection 113, which are connected to each other within the valve block, so that when valve block 100 is connected to a cooling medium system (not illustrated) via the connections, flow paths of the cooling medium system may be temporarily modified. If necessary, cooling medium may be removed via one of connections 111, 112, 113 or reintroduced from attached cooling medium bottles.

Valve block 100 is manufactured by the injection molding method, in which a plastic, in particular a plastic reinforced by additives, is injected into an appropriate mold. The plastic is preferably reinforced using fibers, in particular fiberglass. A particularly suitable plastic is the PA 66 plastic, 30% GF, where GF is the German abbreviation for fiberglass. This plastic meets the requirements for the material of a valve block for cooling medium systems having to be resistant to cooling media and pressure-resistant, in particular pressure-resistant up to a pressure of at least 150 bar.

To be able to regulate the flow through valve block 100, in particular when filling the cooling medium system, valve block 100 usually has a receptacle 135 for a valve for each connection 111, 112, 113 via which connections 111, 112, 113 may be opened and closed. Furthermore, valve block 100 has a receptacle 136 for a vacuum protection valve. Another receptacle 137 is provided for a sight glass, through which the flow of the cooling medium in valve block 100 may be monitored.

Furthermore, at least one, in the present case two, receptacles 131 are provided in valve block 100 for pressure sensors to detect the pressure of the cooling medium. Another receptacle 132 is provided for a vacuum sensor. Finally another receptacle 137, through which illumination may be supplied into valve block 100 for the sight glass, is situated in the valve block.

All receptacles 131, 132, 133, 135, 136, 137 are formed directly during the manufacturing process of valve block 100, so that no reworking is needed.

Receptacles 131, 132, 133, 135, 136, 137 represent openings running from the outside of valve block 100 into the inside of valve block 100. However, during the use of valve block 100 these receptacles are closed and hermetically sealed by different components such as, for example, measuring sensors or valves. The cooling medium system, a cooling medium bottle, or a vacuum pump system may be connected to the inside of valve block 100 only through connections 111, 112, 113. Since high pressures of up to 150 bar may be applied to the cooling medium system, valve block 100 must be designed to be pressure-resistant accordingly. For this purpose, on the one hand, a suitable material is used for valve block 100, as mentioned previously. However, due to the fact that valve block 100 is manufactured by the injection molding method, there is the additional option to provide the surface of valve block 100 with stabilizing structural elements. These are designed, in this case, as ribs 125, which are essentially perpendicular to the surface of valve block 100 and may run longitudinally, transversely, or diagonally. A plurality of ribs 125 preferably runs parallel to one another and is connected to ribs 125 running transversely thereto, which further enhances stability. Other projections in the form of arches or hollow cylinders may also be used as stabilizing structural elements. The purpose of the structural elements is, on the one hand, to reduce the material needed for the manufacture of valve block 100 and, on the other hand, to provide valve block 100 with the necessary pressure resistance and stability.

Depending on the type of structural elements, in particular of ribs 125, it may be advantageous to provide further stabilizing structures within the structural elements projecting from the surface of valve block 100, for example, in the form of openings, in particular in the form of circular holes, to further enhance the stability of the structural elements. The structural elements should preferably have a height such that all edges of a surface lying on the outside span a surface around the valve block on which, for example, an outside housing around the valve block may lie at least partially, so that the structural elements act as shape supports.

FIGS. 2a and 2b show a second exemplary embodiment of a valve block 100′ in two different perspective views, the same components being labeled using the same reference numerals as in FIGS. 1a and 1b. Valve block 100′ differs from valve block 100 according to FIG. 1 essentially by the fact that valve block 100′ has a fourth connection 114, which enables additional options for modifying the flow paths of the cooling medium system or for simultaneously filling and/or draining the valve block when the flow paths of the cooling medium system are modified. Only two connections 111, 112 are needed for a valve block according to the present invention; third connection 113 and fourth connection 113 provide additional advantageous options.

FIGS. 3a and 3b show two different perspective views of a third exemplary embodiment of a valve block 300. Valve block 300 has a first connection 311, a second connection 312, and a third connection 313, which are connected to each other within valve block 300. In the third exemplary embodiment of valve block 300, further different components of a control armature are illustrated, in which valve block 300 according to the present invention, but also valve blocks 100, 100′ according to the first or second exemplary embodiment, may be used.

Receptacles 335 are situated in the valve block, in which valves 350 for opening and closing connections 311, 312, 313 with respect to the cooling medium system or corresponding cooling medium bottles or a vacuum pump system are situated. In another receptacle 336, a vacuum protection valve may be situated, which, however, is not installed in the specific embodiment shown.

In another receptacle 337, a sight glass is provided, through which the flow of the cooling medium through valve block 300 may be monitored. The sight glass is preferably equipped with sight glass illumination 344, which is guided through a receptacle in valve block 300. Finally, valve block 300 has receptacles through which pressure sensors 342 are introduced into valve block 300.

Pressure sensors 342 and sight glass illumination 344 are situated on a PC board 360, which is situated on the outside of valve block 300. All sensors, in particular pressure sensors 342, situated on valve block 300 may be read via PC board 360. Furthermore, PC board 360 makes it possible to activate the sensors and to record and detect the measured data.

Valve block 300 has catch projections 370, via which the height of valves 350 with respect to valve block 300 may be adjusted. By slightly pressing the surface of the adjusting elements, valves 350 may be released from a first position, in which valves 350 are latched, and moved into a second position in which the adjusting elements are situated at a greater height over valve block 300, and may also be twisted to open or close valves 350. By pressing again the surface of the adjusting elements, valves 350 may be latched again in the second position, in which they protrude less above the valve block and in which they preferably may no longer be twisted. A locking and unlocking mechanism 371 may be situated in recesses 373 of ribs 325, locking and unlocking mechanism 371 being actuatable via a pressbutton 372. Thus, on the one hand, valves 350 are situated on valve block 300 in a compact manner; on the other hand, a latching mechanism of this type offers adjustment safety to prevent one of valves 350 from being accidentally opened or closed during operation.

Finally, valve block 300 has structural elements for stabilization, in particular ribs 325, which are comparable to ribs 125 of valve block 100 of the first exemplary embodiment according to FIGS. 1a and 1b or to ribs 125 of valve block 100′ of the second exemplary embodiment according to FIGS. 2a and 2b.

A diagram 400 of a valve block (not illustrated), however, for example, for valve block 100′ according to the second exemplary embodiment, which is illustrated in FIGS. 2a and 2b, is schematically illustrated in FIG. 4. The diagram shows a first connection 411, a second connection 412, a third connection 413, and a fourth connection 414. First connection 411 is connected to a chamber 425 via first connecting line 421; second connection 412 is connected to chamber 425 via a second connecting line 422; third connection 413 is connected to chamber 425 via a third connecting line 423, and fourth connection 414 is connected to chamber 425 via a fourth connecting line 424, so that all connections 411, 412, 413, 414 are connected to each other within the valve block (not illustrated). The user may look into chamber 425 from the outside with the aid of a sight glass 440 to monitor the cooling medium flow through the valve block.

A first valve 431 is situated between first connection 411 and chamber 425; a second valve 432 is situated between second connection 412 and chamber 425; a third valve 433 is situated between third connection 413 and chamber 425, and a fourth valve 434 is situated between fourth connection 414 and chamber 425, to connect the particular connections 411, 412, 413, 414 to the cooling medium system, cooling medium bottles, or a vacuum pump system and to be able to appropriately modify the flow paths.

A vacuum protection valve 435, situated in particular between chamber 425 and a vacuum sensor 446, is preferably situated on chamber 425.

A first pressure sensor 442 is situated between first connection 411 and first valve 431; a second pressure sensor 442 is situated between fourth connection 414 and fourth valve 434, first connection 411 and fourth connection 414 being preferably connected to the cooling medium system to vary the flow paths there. Via second connection 412, the cooling medium system is preferably filled with new cooling medium from a cooling medium bottle; the cooling medium system may preferably be drained or evacuated via third connection 413.

### LIST OF REFERENCE NUMERALS

100 valve block

100′ valve block

111 first connection

112 second connection

113 third connection

114 fourth connection

125 ribs

131 receptacle, pressure sensor

132 receptacle, vacuum sensor

133 receptacle, sight glass illumination

135 receptacle, valve

136 receptacle, vacuum protection valve

137 receptacle, sight glass

300 valve block

311 first connection

312 second connection

313 third connection

325 ribs

335 receptacle, valve

336 receptacle, vacuum protection valve

337 receptacle, sight glass

342 pressure sensor

344 sight glass illumination

350 valve

360 PC board

370 catch projection

371 locking and unlocking mechanism

372 pressbutton

373 recesses

400 diagram

411 first connection

412 second connection

413 third connection

414 fourth connection

421 first connecting line

422 second connecting line

423 third connecting line

424 fourth connecting line

425 chamber

431 first valve

432 second valve

433 third valve

434 fourth valve

435 vacuum protection valve

440 sight glass

442 pressure sensor

446 vacuum sensor

1. A valve block, comprising:
at least a first connection and a second connection, the two connections being connected to each other within the valve block for at least one of: temporarily modifying flow paths in a cooling medium system, filling the cooling medium system and draining the cooling medium system, wherein the valve block is manufactured from a cooling medium-resistant and pressure-resistant plastic.

2. The valve block as recited in claim 1, wherein the plastic is pressure-resistant to approximately 150 bar.

3. The valve block as recited in claim 1, wherein the plastic is a plastic reinforced by additives.

4. The valve block as recited in claim 1, wherein the plastic is a fiber-reinforced plastic.

5. The valve block as recited in claim 1, wherein the valve block is manufactured by an injection molding method.

6. The valve block as recited in claim 1, further comprising:
structural elements that enhance stability of the valve block.

7. The valve block as recited in claim 6, wherein the structural elements include at least one of: arches and ribs.

8. The valve block as recited in claim 1, further comprising:
a third connection.

9. The valve block as recited in claim 1, wherein the connections are molded onto the valve block.

10. The valve block as recited in claim 1, further comprising:
at least one receptacle for a valve, wherein the receptacle is formed on the valve block, and wherein the permits opening and closing at least one of the connections.

11. The valve block as recited in claim 1, further comprising:
catch projections situated on the valve block, wherein the catch projections cooperate with mating catch projections of a valve so that the valve height is adjustable.

12. The valve block as recited in one claim 1, further comprising:
an opening formed in the valve block for the placement of a sight glass.

13. A control armature for measuring, monitoring, and analyzing physical parameters of recirculating cooling media, comprising:
a valve block, the valve block including:
at least a first connection and a second connection, the two connections being connected to each other within the valve block for at least one of: temporarily modifying flow paths in a cooling medium system, filling the cooling medium system and draining the cooling medium system, wherein the valve block is manufactured from a cooling medium-resistant and pressure-resistant plastic.

14. The control armature as recited in claim 13, further comprising:
a sight glass.

15. (canceled)

16. The control armature as recited in claim 14, wherein the sight glass is illuminatable.

17. The control armature as recited in claim 13, wherein the valve block further includes at least one additional connection.

18. The valve block as recited in claim 4, wherein the fiber-reinforced plastic is a fiberglass-reinforced plastic.

19. The valve block as recited in claim 8, further comprising:
a fourth connection.

20. The valve block as recited in claim 9, wherein the connections are extruded onto the valve block.

21. A method for manufacturing a valve block, comprising:
providing at least a first connection and a second connection of the valve block,
connecting the first connection and the second connection to each other within the valve block to perform at least one of: temporarily modifying flow paths in a cooling medium system, filling the cooling medium system, and draining the cooling medium system,
wherein the valve block is manufactured from a cooling medium-resistant and pressure-resistant plastic, and wherein the valve block is manufactured by an injection molding method.
